(19) United States
(12) Patent Application Publication
(10) Pub. No.: US 2026/0160871 A1
(43) Pub. Date: Jun. 11, 2026

(54) OCCUPANCY GRID BASED DYNAMIC FIRING OF ULTRASONIC SENSORS

(71) Applicant: Valeo Schalter und Sensoren GmbH, Bietigheim-Bissingen (DE)

(72) Inventors: Kiran Cherukumilli, Troy, MI (US); Deep Doshi, Troy, MI (US)

(21) Appl. No.: 18/973,536

(22) Filed: Dec. 9, 2024

(51) Int. Cl. G01S 7/524; G01S 15/931

(52) U.S. Cl. CPC G01S 7/524; G01S 15/931

(57) ABSTRACT

A method performed by a controller of a vehicle includes generating and emitting sound signals into an environment around the vehicle using a plurality of ultrasonic sensors arranged on the vehicle by controlling a firing sequence of the plurality of ultrasonic sensors, receiving, at the plurality of ultrasonic sensors, the sound signals as reflected back toward the vehicle by at least one object in the environment, calculating, at the controller, a plurality of relevancy scores for the plurality of ultrasonic sensors, each of the plurality of relevancy scores corresponding to a relevance of one of the plurality of ultrasonic sensors to the at least one object, adjusting, at the controller, the firing sequence of the plurality of ultrasonic sensors based on the plurality of relevancy scores, and controlling, at the controller, the plurality of ultrasonic sensors to generate and emit the sound signals in accordance with the adjusted firing sequence.

### TECHNICAL FIELD

The present disclosure relates to systems and methods for using ultrasonic sensors to monitor vehicle surroundings.

### BACKGROUND

To enhance safety and security, vehicles may be equipped with various features to monitor the environment around the vehicle, such as by capturing and recording images of the environment. In some examples, ultrasonic sensors are used to monitor the environment around the vehicle (e.g., while the vehicle is stationary and/or moving).

### SUMMARY

A method performed by a controller of a vehicle includes generating and emitting sound signals into an environment around the vehicle using a plurality of ultrasonic sensors arranged on the vehicle by controlling a firing sequence of the plurality of ultrasonic sensors, receiving, at the plurality of ultrasonic sensors, the sound signals as reflected back toward the vehicle by at least one object in the environment, calculating, at the controller, a plurality of relevancy scores for the plurality of ultrasonic sensors, each of the plurality of relevancy scores corresponding to a relevance of one of the plurality of ultrasonic sensors to the at least one object, adjusting, at the controller, the firing sequence of the plurality of ultrasonic sensors based on the plurality of relevancy scores, and controlling, at the controller, the plurality of ultrasonic sensors to generate and emit the sound signals in accordance with the adjusted firing sequence.

In an embodiment, a system is configured to perform functions corresponding to steps of various methods described herein.

In an embodiment, a tangible, non-transitory computer-readable medium stores instructions that, when executed, cause a processing device to perform any operation of any method disclosed herein.

In an embodiment, a system includes a memory device storing instructions and a processing device communicatively coupled to the memory device. The processing device executes the instructions to perform any operation of any method disclosed herein.

Other technical features may be readily apparent to one skilled in the art from the following figures, descriptions, and claims.

### BRIEF DESCRIPTION OF THE DRAWINGS

FIG. 1A illustrates a schematic of an example vehicle, shown from a top view, according to the present disclosure.

FIG. 1B shows an example system configured to monitor the surroundings of the vehicle using ultrasonic sensors according to the present disclosure.

FIG. 2 shows an example occupancy grid map according to the present disclosure.

FIG. 3 illustrates a block diagram of a computer or computing system according to the present disclosure.

FIG. 4 illustrates steps of an example method for monitoring vehicle surroundings using ultrasonic sensors according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Some automotive vehicles may be equipped with a system that monitors the environment/surroundings of the vehicle while stationary (parked, turned off, etc.) and/or moving and senses and records images of the surroundings. Such a system enhances the safety and security of a vehicle by using various types of cameras and sensors for monitoring the environment. The images may be used in real-time (e.g., for autonomous or semi-autonomous driving), captured images may be stored for later viewing, etc.

Some systems use a plurality (e.g. an array) of ultrasonic sensors to monitor the environment around the vehicle. Typically, ultrasonic sensors operate in accordance with a fixed activation (“firing”) rate or sequence. For example, sensor timing and/or firing sequence (e.g., timing relative to other sensors) may be hard-coded in system firmware. For each firing event, a respective sensor is configured to transmit an ultrasonic signal (e.g., a trigger signal) and receive and process a corresponding echo signal (i.e., a signal reflected back from an object in the environment). As one example, individual sensors in a plurality of sensors are fired in accordance with a predetermined sequence, which may be repeated at predetermined intervals (e.g., in accordance with a predetermined sequence, cycle, period, etc.). Further, each sensor may have a fixed latency. The firing sequence may be configured in accordance with the number of sensors and respective latencies to cover a desired field of view while maintaining a minimum desired latency.

Systems and methods according to the present disclosure are configured to implement, based on an occupancy grid, a dynamic firing sequence for an array of ultrasonic sensors. As used herein, a “dynamic” firing sequence refers to a firing sequence that is dynamically adjustable (i.e., not fixed) such that firing sequence, firing rates of individual sensors, etc. can be adjusted based on detection of objects in the environment. Accordingly, rather than maintaining the same, fixed firing sequence and firing rate, systems and methods according to the present disclosure are configured to selectively adjust firing sequence and/or firing rates of individual sensors in an array of ultrasonic sensors based on detection of objects in the environment. As used herein, “firing sequence” may generally refer to one or both of (i) an order or sequence in which individual sensors are fired and (ii) respective firing rates of the individual sensors.

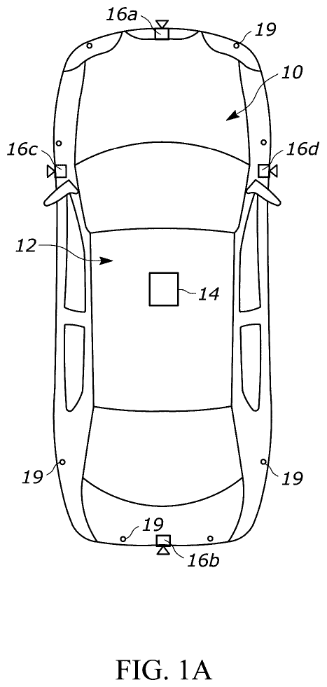

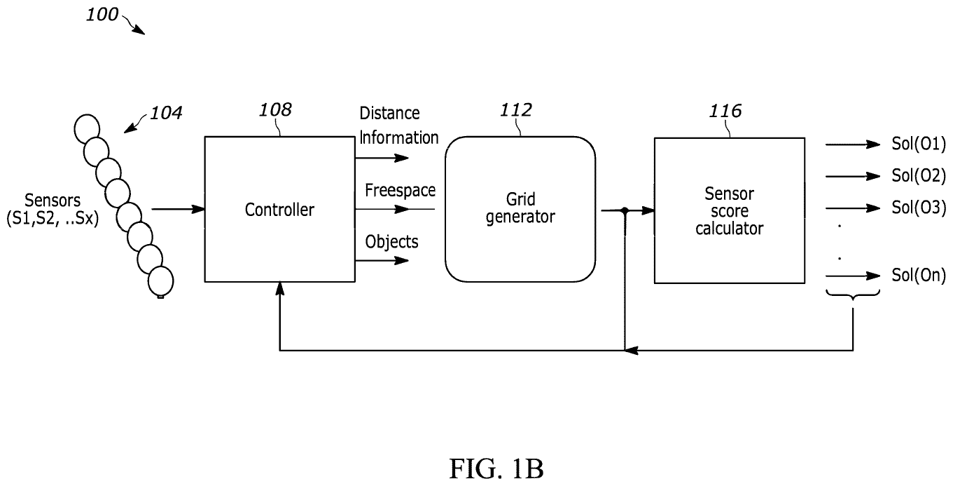

FIG. 1A illustrates a schematic of a vehicle 10 according to an embodiment, shown here from a top view. The vehicle 10 is a passenger car, but can be other types of vehicles such as a truck, van, or sports utility vehicle (SUV), or the like. In some examples, the vehicle 10 includes a camera system 12 which includes an electronic control unit (ECU) 14 connected to a plurality of cameras 16a, 16b, 16c, and 16d. The ECU 14 may include one or more processors programmed to process the images data associated with the cameras 16a-d. Further, as will be described below in more detail, the vehicle 10 includes a plurality of proximity sensors (e.g., ultrasonic sensors) 19. In some examples, the vehicle 10 may include additional types of sensors (e.g., other types of sensors used for an advanced driver assistance system, or ADAS), such as radar, sonar, LiDAR, etc. The proximity sensors 19 may be connected to a designated ECU configured to develop a sensor map of objects external to the vehicle. Alternatively, the proximity sensors can be connected to the ECU 14. As described herein, the cameras 16a-d, the proximity sensors 19, and/or other types of sensors may be referred to as types of image sensors.

The ECUs disclosed herein may more generally be referred to as a controller or processor. In the case of an ECU associated with the proximity sensors 19 in accordance with the principles of the present disclosure, the ECU is configured to receive sensor data from the various proximity sensors (or their respective processors), process the information, and output a sensor map of objects surrounding the vehicle. In this disclosure, the terms “controller,” “module,” and “system” may refer to, be part of, or include processor hardware (shared, dedicated, or group) that executes code and memory hardware (shared, dedicated, or group) that stores code executed by the processor hardware. The code is configured to provide the features of the controller and systems described herein. In one example, the controller may include a processor, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL. The computer-executable instructions of the programs may be configured to, upon execution by the processor, cause the object classification technique and algorithms described herein.

As shown in FIG. 1A, the vehicle 10 includes eight (8) of the proximity sensors 19, although more than eight of the proximity sensors 19 may be provided. As one example, eighteen (18) or more of the proximity sensors 19 may be provided to capture a 360 degree view of the surroundings of the vehicle. As will be described below in more detail, the ECU 14 is configured to control and activate the proximity sensors 19, receive, record and store data captured by the proximity sensors 19, etc.

In an example, the proximity sensors 19 are implemented using low-cost (e.g., relative to other types of ADAS sensors) and low power consumption ultrasonic sensors configured to continuously monitor the surroundings of the vehicle 10 (e.g., a 360 degree view of the environment around the vehicle 10). The proximity sensors 19 may be configured to monitor the surroundings of the vehicle 10 while the vehicle is moving (e.g., being driven, by a driver, autonomously or semi-autonomously, etc.) and/or when the car is stationary (e.g., parked, powered off, unattended and/or unoccupied, etc.). In an example, each of the proximity sensors 19 is configured to operate at a data acquisition frequency corresponding to 0.4-0.5 watts of power consumption. Systems and methods according to the present disclosure are configured to implement, based on an occupancy grid, a dynamic firing sequence for the proximity sensors 19 as described below in more detail.

Data generated by the proximity sensors 19 is processed by the ECU 14. For example, the data generated by the proximity sensors 19 (i.e., responsive to objects in the environment detected by the ultrasonic sensors 104) includes distance information (e.g., sensor distance information) obtained using one or more free space detection techniques. Generally, distance information may include simple numerical data indicating a distance, in known or predetermined units, between an object and a given sensor. This type of numerical data requires less memory space and other resources and facilitates simple calculation and processing. Further, precise distances of objects, and changes in distances/trajectories of objects relative to the vehicle 10, can be obtained.

Further, physical properties of the proximity sensors 19 (e.g., physical properties of ultrasonic sensors) enable operation in different types of weather conditions such as rain, fog, etc., different times of day/lighting conditions, and so on. For example, since ultrasonic sensors operate using sound waves and sound waves are able to travel through different weather and lighting conditions, systems and methods according to the present disclosure are configured to operate regardless of weather and other environmental conditions, and data obtained by the proximity sensors 19 is accurate/reliable regardless of weather and other environmental conditions.

FIG. 1B shows components of an example system 100 (e.g., as implemented within and/or by the vehicle 10) configured to monitor the surroundings of the vehicle 10 using ultrasonic sensors 104 (S1, S2, . . . , and Sx) and a controller 108. For example, the ultrasonic sensors 104 correspond to the proximity sensors 19 of FIG. 1A and the controller 108 corresponds to the ECU 14 of FIG. 1A.

The ultrasonic sensors 104 are configured to generate sound signals or waves (e.g., sound wave pulses) and emit the sound waves into the environment around the vehicle. The sensors 104 generate the sound waves at a frequency higher than an audible frequency range, such as in a range of 45 to 55 kHz. The ultrasonic sensors 104 are arranged on (e.g., spaced around) the vehicle to facilitate projection of the sound waves in a manner that provides a 360 degree view of the environment. For example, each of the sensors 104 has a respective coverage area (e.g., a cone-shaped coverage area), and the sensors 104 are spaced such that each coverage area overlaps with adjacent coverage areas. Objects within the coverage areas cause the sound waves to reflect and bounce back towards the sensors 104.

The sensors 104 receive the reflected sound waves (e.g., via an audio input device, such as a microphone or other transducer), which indicate distances between the sensors 104 and the objects. For example, the sensors 104 may be configured to determine an amount of time for the sound waves to travel from the sensors 104 to the objects and back to the sensors from the objects. Distance between the sensors 104 and the objects can then be calculated based on the determined amount of time (e.g., using a known speed of the sound waves at a given temperature). In other examples, the controller 108 may be configured to calculate the distances.

The sensors 104 may be configured to generate the sound waves (e.g., sound wave pulses) and sample reflected sound waves at a given sampling rate or range, such as once every 5-240 ms. The sensors 104 may operate at same or different sampling rates or frequencies. One or more of the sensors 104 may be in a transmit mode (e.g., generating sound waves) will one or more others of the sensors 104 may be in a receive mode (e.g., receiving reflected sound waves). As one example, one of the sensors 104 may be transmitting/generating sound waves while two or more adjacent sensors 104 (e.g., sensors 104 on either side of the transmitting sensor 104) receive the reflected sound waves. For example sensors 104 may be configured to operate in accordance with trilateration and/or triangulation techniques using both direct measurements (e.g., measurements where the same sensor that transmits a signal listens for and receives the reflected signal) and indirect measurements (e.g., measurements where one sensor fires a signal and neighboring/adjacent sensors listen for and receive the reflected signal.

The controller 108 is configured to receive outputs of the sensors 104 (“sensor outputs”) and generate one or more signals indicative of objects in the environment based on the sensor outputs. For example, the controller 108 may generate: distance information obtained using one or more free space detection techniques; free space information (e.g., information indicating regions of the environment around the vehicle 10 occupied by and not occupied by objects); and one or signals indicating objects detected in the environment.

The controller 108 may be further configured to monitor/track the objects (and movement, trajectories, etc. of the objects) in the environment over time. For example, the controller 108 may be configured to track (e.g., receive, process, and store data indicative of): the number of objects in the environment (e.g., objects within a predetermined range of the vehicle); respective distances between the vehicle and/or sensors 104 and the objects; direction of movement/travel, velocity, and acceleration of the objects relative to the vehicle; and angles/trajectories of the objects relative to the vehicle. In an example, the controller 108 may be configured to generate, store, and update a motion profile for each of the objects in the environment. The motion profile may indicate, for each object, a current location of the object, a movement path or direction/trajectory, velocity, etc.

The controller 108 is configured to perform one or more actions in response to detection of objects in the environment. For example, the controller 108 may generate and transmit alerts (e.g., to an owner/driver of the vehicle) in response to detecting objects in the environment. The alert may be transmitted based on a preferred mode of alert selected by the owner, may be transmitted via two or more alert mechanisms, etc., such as text message, email, cellular call, a smartphone app, etc. In other examples, the controller 108 may be configured to control various functions of the vehicle 10 (e.g., autonomous or semi-autonomous driving functions) in response to detecting objects in the environment. The controller 108 according to the present disclosure is further configured to selectively adjust firing sequence and/or firing rates of the sensors 104 in response to detecting objects in the environment as described below in more detail.

As one example, the controller 108 may be configured to generate and store an occupancy grid map of the environment, including objects in the environment and velocities, trajectories/movement directions, etc. of the objects. In other examples, a computing device or component external to/separate from (e.g., a grid generator 112) may be configured to generate the occupancy grid map. Although shown as a separate component in FIG. 1B, in some examples the controller 108 may perform all or some of the functions of the grid generator 112.

The system 100 may include a sensor score calculator 116 configured to generate respective relevancy scores for each of the sensors 104 as described below in more detail. Similar to the grid generator 112, the sensor score calculator 116 may be implemented as a separate component and/or the controller 108 may be configured to implement all or some of the functions of the sensor score calculator. The relevancy scores calculated for and assigned to the sensors 104 are used to identify one or more sensors of interest (SoI) for respective objects (e.g., objects O1, O2, O3, . . . , and On) detected in the environment. For example, SoI(O1) may correspond to a sensor of interest for the object O1, SoI(O2) may correspond to a sensor of interest for the object O2, etc. As one example, a sensor having the highest relevancy score for a given object is selected as the sensor of interest for that object.

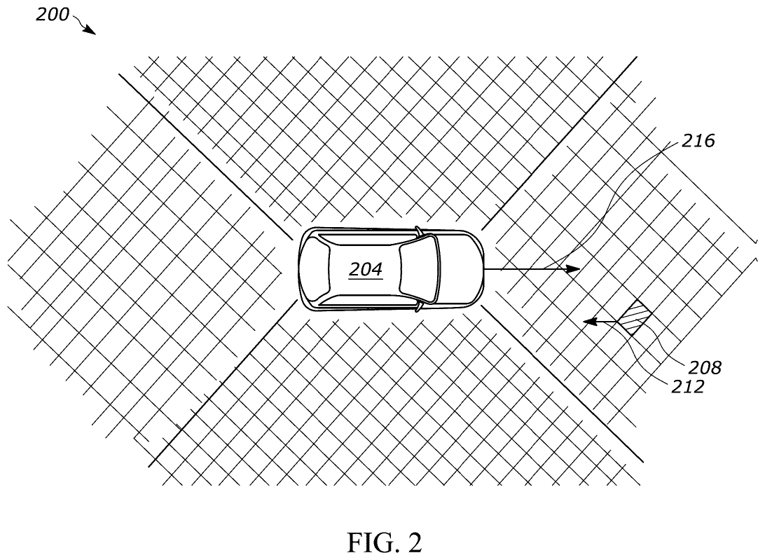

FIG. 2 shows an example occupancy grid or grid map 200 generated by the grid generator 112, the controller 108, etc. The occupancy grid map 200 includes a vehicle 204 and an object 208 in the environment around the vehicle 204. The occupancy grid map 200 may further include a direction of movement 212 of the object 208. As shown, the grid map 200 is comprised of a plurality of grid blocks representing the environment/surroundings of the vehicle 204. For example, the grid map 200, grid blocks, the vehicle 204, and the object 208 may be represented by values in an X, Y coordinate system. Distances between the vehicle 204 and the object 208 may be calculated, measured and/or represented in units of grid blocks and/or real-world distance measurements (e.g., meters), converted between grid blocks and real-world distance measurements, etc. Similarly, velocities may be calculated or measured in units of grid blocks and/or real-world distance measurements (e.g., meters per second). Distance in grid block units may be referred to as “free space depth.” Similarly, velocity in grid block units may be referred to as “free space velocity.”

Accordingly, for the object 208 and other objects in the environment, the controller 108 may be configured to determine various characteristics of the environment, including, but not limited to: a number of dynamic objects in the environment, a distance between the vehicle 204 and the object 208 (e.g. a free space depth); a velocity of the object 208; and a direction of movement of the object 208. For example, direction of movement may be represented as an angle of the movement direction/trajectory of the object 208 relative to the vehicle 204 (e.g., with a position directly in front of the vehicle, as indicated at 216, corresponding to 90 degrees), and may be represented in units such as radians, degrees, etc.

For each of the sensors 104, the relevancy score is calculated based on a grid occupancy region (e.g., a region or portion of the grid 200 occupied by an object) and a region or portion of a field-of-view of the sensor 104 that overlaps the grid occupancy region. Accordingly, the relevancy score for each sensor 104, for a given object, indicates an amount of the field-of-view of the sensor 104 that overlaps the object.

The relevancy score may correspond to an Intersection over Union (IoU) score. The IoU score corresponds to (i) an area of an intersection (e.g., an area of overlap, such as an area measured in grid units or cells) between the region of the grid 200 occupied by the object 208 and the field-of-view of the sensor 104 divided by (ii) an area of a region corresponding to a union of the region occupied by the object 208 and the field-of-view of the sensor 104. In other words, the relevancy score IoU for a sensor, for an object Oi, can be calculated in accordance with IoU=[G(Oi)∩G(Sensor FoV)]/[G(Oi)∪G(Sensor FoV)], where G(Oi) is a region of the grid 200 occupied by the object and G(Sensor FoV) is a region of the grid 200 corresponding to the field-of-view of the sensor. Accordingly, the relevance score IoU is indicative of a portion or percentage of the object 208 within the field-of-view of a given sensor. Further, as the object 208 moves (e.g., away from the vehicle 204, toward the vehicle 204, etc.), the relevancy score is updated accordingly and therefore may increase or decrease for a given sensor 104 over time.

Although described with respect to the IoU score, in other examples the relevancy score may be calculated using other techniques indicative of a portion of the object 208 within the field-of-view of a given sensor 104.

A firing sequence and/or firing rates of the sensors 104 can be adjusted based on detected objects and the calculated relevancy scores. For example, the sensors 104 may be configured to fire in accordance with a fixed or predetermined sequence and fixed or predetermined firing/activation rates. The “fixed” or “predetermined” sequence and or rate may correspond to default or calibrated values, values obtained at vehicle startup (e.g., prior to any objects being detected), an “idle sequence rate,” etc.

In an example, the controller 108 adjusts the firing sequence and/or firing rates to prioritize sensors having higher relevancy scores (e.g., IoU scores) for detected objects. For example, a sensor having a highest relevancy score may be moved upward/earlier in the firing sequence while sensors having lower relevancy scores are moved downward/later in the firing sequence and/or omitted from the firing sequence. In other words, a sequence or order in which the sensors are fired may be modified based on the relevancy scores. Further, sensors having higher relevancy scores (and, in some examples, sensors adjacent to sensors having higher relevancy scores) may be fired at a greater firing rate while sensors having lower relevancy scores may be fired at a lower firing rate. In still other examples, in a given firing sequence, sensors having higher relevancy scores may be fired multiple times (e.g., a sensor having a highest relevancy score may be fired two, three, or more times in a given firing sequence while other sensors are fired only one time or omitted altogether).

In one example, for a default or idle firing sequence, the sensors 104 are fired at respective intervals of 1n, 2n, 3n, . . . , and mn, where n is a time interval and m is a multiple of the time interval. One or more of the sensors 104 may be fired at a given one of the time intervals. Accordingly, a sensor having a highest relevancy score (and sensors adjacent to that sensor) for a detected object of interest may be assigned the 1n time interval. In some examples, a sensor having the highest relevancy score may be assigned multiple time intervals (e.g., the 1n time interval, the 3n time interval, the 5n time interval, etc.). In one example, the sensors 104 are assigned time intervals in accordance with a descending order of respective relevancy scores (i.e., as relevancy score decreases, the assigned time interval increases, and vice versa).

Firing sequence and/or firing rates may be further adjusted based on motion profiles for detected objects. For example, if an object is moving away from the vehicle 204, sensors having the highest relevancy score for that object may not be given higher priority. Similarly, if multiple objects are detected, a sensor having the highest relevancy score for an object moving toward the vehicle 204 may be assigned an earlier time interval and/or greater firing rate than a sensor having the highest relevancy score for an object moving away from the vehicle 204. In still another example, other characteristics such as size of the object, speed of the object, etc. may be used to determine whether and how to adjust the firing sequence and/or firing rates. As one example, the relevancy scores may be weighted based on the characteristics of the object such that relevancy scores for sensors corresponding to objects moving toward the vehicle 204, at a greater speed toward the vehicle 204, etc. are weighted higher than relevancy scores for sensors corresponding to objects moving away from the vehicle 204, at a lower speed toward the vehicle 204, etc. In some examples, in response to multiple objects being detected, each sensor may be assigned multiple relevancy scores.

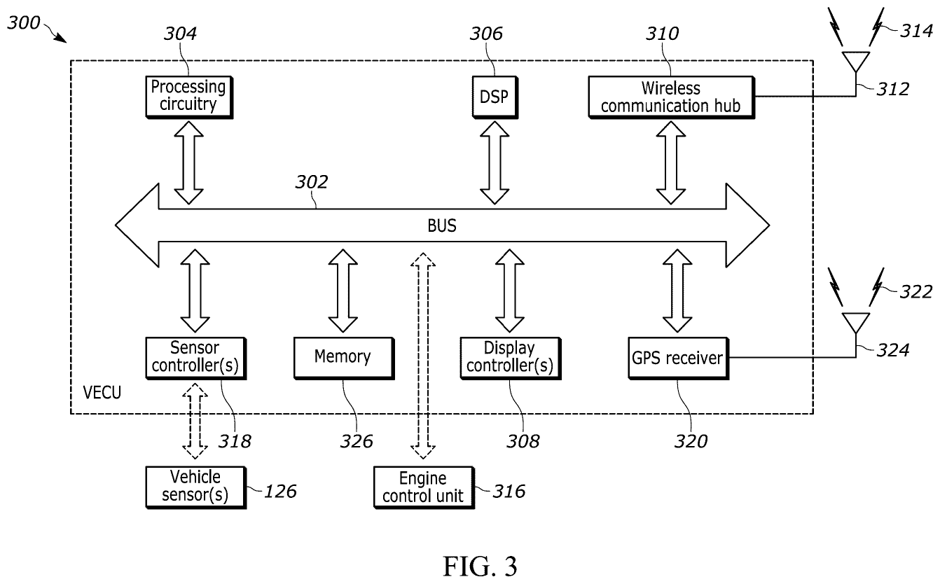

FIG. 3 is a block diagram of internal components of an exemplary embodiment of a computer or computing system 300 configured to implement the systems and methods described above. In this embodiment, the computing system 300 may be embodied at least in part in a vehicle electronics control unit (VECU) or other computing system of a vehicle, such as the vehicles 10 and 204 of FIGS. 1A and 2. It should be noted that FIG. 3 is meant only to provide a generalized illustration of various components, any or all of which may be utilized as appropriate. It can be noted that, in some instances, components illustrated by FIG. 3 can be localized to a single physical device and/or distributed among various networked devices, which may be disposed at different physical locations.

The computing system 300 has hardware elements that can be electrically coupled via a BUS 302. The hardware elements may include processing circuitry 304 which can include, without limitation, one or more processors, one or more special-purpose processors (such as digital signal processing (DSP) chips, graphics acceleration processors, application specific integrated circuits (ASICs), and/or the like), and/or other processing structure or means. The above-described processors can be specially-programmed to perform the operations disclosed herein, including, among others, image processing, data processing, and implementation of the machine learning models described above. Some embodiments may have a separate DSP 306, depending on desired functionality. The computing system 300 can also include one or more display controllers 308, which can control the display devices disclosed above, such as an in-vehicle touch screen, screen of a mobile device, and/or the like.

The computing system 300 may also include a wireless communication hub 310, or connectivity hub, which can include a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication hub 310 can permit data to be exchanged with network 114, wireless access points, other computing systems, etc. The communication can be carried out via one or more wireless communication antenna 312 that send and/or receive wireless signals 314.

The computing system 300 can also include or be configured to communicate with an engine control unit 316, or other type of controller 108 described herein. In the case of a vehicle that does not include an internal combustion engine, the engine control unit may instead be a battery control unit or electric drive control unit configured to command propulsion of the vehicle. In response to instructions received via the wireless communications hub 310, the engine control unit 316 can be operated in order to control the movement of the vehicle during, for example, a driving task.

The computing system 300 also includes vehicle sensors 126 such as the ultrasonic sensors 104 described above with reference to FIGS. 1A and 1B. Sensors can include, without limitation, one or more accelerometer(s), gyroscope(s), camera(s), radar(s), LiDAR(s), odometric sensor(s), and ultrasonic sensor(s), as well as magnetometer(s), altimeter(s), microphone(s), proximity sensor(s), light sensor(s), and the like. These sensors can be controlled via associated sensor controller(s) 318.

The computing system 300 may also include a GPS receiver 320 configured to receive signals 322 from one or more GPS satellites using a GPS antenna 324. The GPS receiver 320 can extract a position of the device, using conventional techniques, from satellites of an GPS system, such as a global navigation satellite system (GNSS) (e.g., Global Positioning System (GPS)), Galileo, GLONASS, Compass, Galileo, Beidou and/or other regional systems and/or the like.

The computing system 300 can also include or be in communication with a memory 326. The memory 326 can include, without limitation, local and/or network accessible storage, a disk drive, a drive array, an optical storage device, a solid-state storage device, such as a RAM which can be programmable, flash-updateable and/or the like. Such storage devices may be configured to implement any appropriate data stores, including without limitation, various file systems, database structures, and/or the like. The memory 326 can also include software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods, thereby resulting in a special-purpose computer.

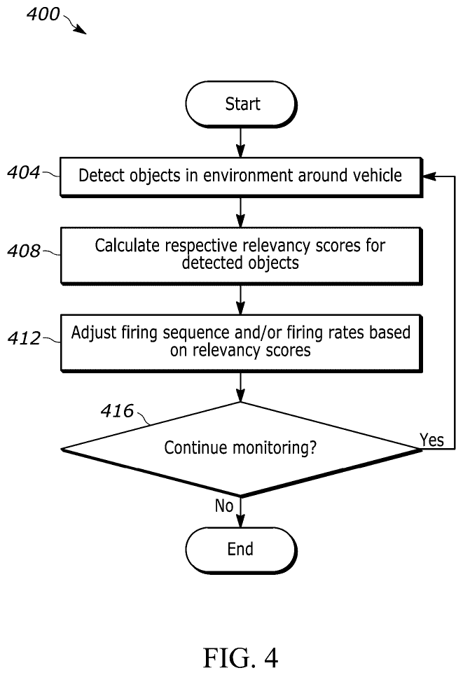

FIG. 4 illustrates steps of an example method 400 for monitoring vehicle surroundings using ultrasonic sensors as described herein. One or more computing devices, controllers, systems, processors or processing devices, circuitry, etc. as described herein may be configured to perform the method 400. For example, a controller such as the controller 108, operating within the system 100, all or portions of which may be implemented within a vehicle, is configured to perform the method 400.

At 404, the method 400 includes detecting, using ultrasonic sensors, objects in the environment around the vehicle as described herein. Using the ultrasonic sensors includes controlling the sensors to fire in an initial firing sequence and/or at an initial firing rate. The initial firing sequence/rates may correspond to default values, startup values, and so on.

At 408, the method 400 includes calculating respective relevancy scores for each sensor for the detected objects. For example, calculating the relevancy scores includes calculating an IoU score as described herein. In various examples, multiple relevancy scores may be calculated for each sensor, the relevancy scores may be weighted based on characteristics of the detected objects, etc.

At 412, the method 400 includes adjusting the firing sequence and/or firing rates of the sensors based on the relevancy scores. Adjusting the firing sequence may include assigning timer intervals earlier in the firing sequence to sensors having higher relevancy scores as described above.

At 416, the method 400 includes determining whether to continue monitoring the environment around the vehicle. If true, the method 400 continues to 404. If false, the method 400 ends.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These memory devices may be non-transitory computer-readable storage mediums for storing computer-executable instructions which, when executed by one or more processors described herein, can cause the one or more processors to perform the techniques described herein. The processor and the memory can be supplemented by, or incorporated in, special purpose logic circuitry.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method performed by a controller of a vehicle, the method comprising:
generating and emitting sound signals into an environment around the vehicle using a plurality of ultrasonic sensors arranged on the vehicle, wherein generating and emitting the sound signals includes controlling a firing sequence of the plurality of ultrasonic sensors;
receiving, at the plurality of ultrasonic sensors, the sound signals as reflected back toward the vehicle by at least one object in the environment;
calculating, at the controller, a plurality of relevancy scores for the plurality of ultrasonic sensors, wherein each of the plurality of relevancy scores corresponds to a relevance of one of the plurality of ultrasonic sensors to the at least one object;
adjusting, at the controller, the firing sequence of the plurality of ultrasonic sensors based on the plurality of relevancy scores; and
controlling, at the controller, the plurality of ultrasonic sensors to generate and emit the sound signals in accordance with the adjusted firing sequence.

2. The method of claim 1, wherein calculating the plurality of relevancy scores includes calculating the plurality of relevancy scores based on a portion of the at least one object within respective fields-of-view of the plurality of ultrasonic sensors.

3. The method of claim 1, wherein the plurality of relevancy scores includes a plurality of Intersection over Union (IoU) scores.

4. The method of claim 3, wherein each of the IoU scores corresponds to (i) an area of an intersection between a region in the environment occupied by the at least one object and a field-of-view of one of the plurality of ultrasonic sensors divided by (ii) an area corresponding to a union of the region occupied by the object and the field-of-view of the one of the plurality of ultrasonic sensors.

5. The method of claim 1, further comprising, at the controller, determining an occupancy grid of the environment and calculating the plurality of relevancy scores based on the occupancy grid.

6. The method of claim 1, wherein controlling the plurality of ultrasonic sensors in accordance with the adjusted firing sequence includes adjusting respective firing rates of the plurality of ultrasonic sensors.

7. The method of claim 1, wherein controlling the plurality of ultrasonic sensors in accordance with the adjusted firing sequence includes assigning time intervals based on the plurality of relevancy scores.

8. A system configured to monitor an environment around a vehicle, the system comprising:
a plurality of ultrasonic sensors arranged on the vehicle, wherein the plurality of ultrasonic sensors are configured to (i) generate and emit sound signals into the environment around the vehicle using the plurality of ultrasonic sensors, wherein generating and emitting the sound signals includes controlling a firing sequence of the plurality of ultrasonic sensors, and (ii) receive the sound signals as reflected back toward the vehicle by at least one object in the environment; and
a controller configured to
calculate a plurality of relevancy scores for the plurality of ultrasonic sensors, wherein each of the plurality of relevancy scores corresponds to a relevance of one of the plurality of ultrasonic sensors to the at least one object,
adjust the firing sequence of the plurality of ultrasonic sensors based on the plurality of relevancy scores, and
control the plurality of ultrasonic sensors to generate and emit the sound signals in accordance with the adjusted firing sequence.

9. The system of claim 8, wherein calculating the plurality of relevancy scores includes calculating the plurality of relevancy scores based on a portion of the at least one object within respective fields-of-view of the plurality of ultrasonic sensors.

10. The system of claim 8, wherein the plurality of relevancy scores includes a plurality of Intersection over Union (IoU) scores.

11. The system of claim 10, wherein each of the IoU scores corresponds to (i) an area of an intersection between a region in the environment occupied by the at least one object and a field-of-view of one of the plurality of ultrasonic sensors divided by (ii) an area corresponding to a union of the region occupied by the object and the field-of-view of the one of the plurality of ultrasonic sensors.

12. The system of claim 8, wherein the controller is further configured to determine an occupancy grid of the environment and calculate the plurality of relevancy scores based on the occupancy grid.

13. The system of claim 8, wherein controlling the plurality of ultrasonic sensors in accordance with the adjusted firing sequence includes adjusting respective firing rates of the plurality of ultrasonic sensors.

14. The system of claim 8, wherein controlling the plurality of ultrasonic sensors in accordance with the adjusted firing sequence includes assigning time intervals based on the plurality of relevancy scores.

15. A processor configured to execute instructions stored on a non-transitory computer-readable medium, wherein executing the instructions causes the processor to:
generate and emit sound signals into an environment around a vehicle using a plurality of ultrasonic sensors arranged on the vehicle, wherein generating and emitting the sound signals includes controlling a firing sequence of the plurality of ultrasonic sensors;
receive, at the plurality of ultrasonic sensors, the sound signals as reflected back toward the vehicle by at least one object in the environment;
calculate a plurality of relevancy scores for the plurality of ultrasonic sensors, wherein each of the plurality of relevancy scores corresponds to a relevance of one of the plurality of ultrasonic sensors to the at least one object;
adjust the firing sequence of the plurality of ultrasonic sensors based on the plurality of relevancy scores; and
control the plurality of ultrasonic sensors to generate and emit the sound signals in accordance with the adjusted firing sequence.

16. The processor of claim 15, wherein calculating the plurality of relevancy scores includes calculating the plurality of relevancy scores based on a portion of the at least one object within respective fields-of-view of the plurality of ultrasonic sensors.

17. The processor of claim 15, wherein the plurality of relevancy scores includes a plurality of Intersection over Union (IoU) scores.

18. The processor of claim 17, wherein each of the IoU scores corresponds to (i) an area of an intersection between a region in the environment occupied by the at least one object and a field-of-view of one of the plurality of ultrasonic sensors divided by (ii) an area corresponding to a union of the region occupied by the object and the field-of-view of the one of the plurality of ultrasonic sensors.

19. The processor of claim 15, wherein executing the instructions further causes the processor to determine an occupancy grid of the environment and calculate the plurality of relevancy scores based on the occupancy grid.

20. The processor of claim 15, wherein controlling the plurality of ultrasonic sensors in accordance with the adjusted firing sequence includes at least one of (i) adjusting respective firing rates of the plurality of ultrasonic sensors and (ii) assigning time intervals based on the plurality of relevancy scores.
